(19) United States
(12) Patent Application Publication
(10) Pub. No.: US 2013/0093198 A1
(43) Pub. Date: Apr. 18, 2013

(54) Sash Window Tilt Latch Accommodating Varying Rail/Stile Cross-Sectional Arrangements

(71) Applicants: Luke Liang, Irvington, NJ (US); Tong Liang, Guangzhou (CN); David Chen, Guangzhou (CN)

(72) Inventors: Luke Liang, Irvington, NJ (US); Tong Liang, Guangzhou (CN); David Chen, Guangzhou (CN)

(21) Appl. No.: 13/649,320

(22) Filed: Oct. 11, 2012

Related U.S. Application Data
(60) Provisional application No. 61/546,581, filed on Oct. 13, 2011.

(51) Int. Cl. E05C 1/10

(52) U.S. Cl. CPC E05C 1/10
USPC 292/163

(57) ABSTRACT

A latch is adapted to accommodate its installation into any one of several sash window frames, having different cross-sectional frame arrangements and setback distances. The latch includes a housing, spring and latch bolt. The housing includes a top plate, a side wall, and a bottom wall, which form a cavity, with the latch bolt being slidably received therein. The spring biasing the latch bolt to protrude out from a housing opening. The bottom wall includes a contoured peripheral opening configured to form a first flexible platform and a second flexible platform, each having one or more tabs thereon, formed by first and second surfaces converging to form an apex. The first surface of each tab accommodates latch installation for varying sash window frame set-back distances, with the second surface being configured to cause the platform to deflect into said cavity when being engaged during the installation into the sash frame.

### CROSS REFERENCES TO RELATED APPLICATIONS

This application claims priority on U.S. Provisional Application Ser. No. 61/546,581 filed on Oct. 13, 2011, the disclosures of which are incorporated herein by reference.

### FIELD OF THE INVENTION

This invention relates to a latch for use in a sash window, and more particularly to a latch being adapted for ease of installation into different sized rail openings and/or rail/jam cross-sectional shapes for the sash window.

### BACKGROUND OF THE INVENTION

Sash windows that slide within a master window frame have been used in homes for centuries, but have nonetheless experienced many foreseeable upgrades and have also been recently subjected to much innovative advancement. The sash windows, which may be single-hung or double-hung, generally comprise a sash frame and a glazing secured therein. The sash frame is usually made of four components, the two sides, referred to as stiles, and the two connecting members, which are referred to generally as rails. The upper sash window is generally described as having a top rail and a “meeting rail,” while the lower sash window is generally described as having a “meeting rail” and a bottom rail.

These four members of a sash window that hold the glazing were traditionally made of wood; however, today they may be made of metal or plastic, and may also be made to comprise any particularly desirable cross-sectional shape to correspond to the cross-sectional shape of the master window frame. A very innovative advancement made to sash windows has been the incorporation of a pivoting means to one end of the sash frame, along with left-hand and right-hand tilt latches installed at the junction of the meeting rail and the left-hand and right-hand stiles to permit tilting of the sash window out from the master window frame, which is particularly desirable for cleaning of the glazing.

Since the exact cross-sectional shape of the sash stile may vary, such variations can similarly necessitate that either the latch configuration/envelope itself, or the latch's installation into the sash window rail/stile must be customized for the particular cross-sectional arrangement of the frame. This adds additional cost to the designer/vendor of latch hardware, and necessitates the maintenance of a larger inventory of various different latches that may be suitably used on different window frames. The latch of the present invention is specially conceived to address that problem and permit its singular use on many different window frames having different cross-sectional arrangements.

### OBJECTS OF THE INVENTION

It is an object of the invention to provide a tilt latch that may releasably secure a sash window to a master window frame and furthermore permit sliding and pivotal movement of the sash relative to the master window frame.

It is another object of the invention to provide a tilt latch that may have a housing with a slidable latch bolt therein, being biased to be in an extended position to engage the master window frame.

It is a further object of the invention to provide a housing being particularly adapted to be installable within an opening of a sash window irrespective of a setback distance inherent to a particular sash frame cross-section.

Further objects and advantages of the invention will become apparent from the following description and claims, and from the accompanying drawings.

### SUMMARY OF THE INVENTION

A tilt latch of the present invention is specially adapted to be installable in the sash window frames of various different windows for which the cross-sectional shape of the sash stile may vary. Ordinarily, such variations would necessitate that either the latch configuration/envelope itself, or the latch's installation into the sash window rail/stile must be customized for the particular cross-sectional arrangement of the frame, which adds additional cost. The latch of the present invention is specially conceived to address that problem and obviates the need for an inventory of several different latch configurations to accommodate different sash frame cross-sectional arrangements.

### BRIEF DESCRIPTION OF THE DRAWINGS

FIG. 1 is a bottom perspective view showing a first multiple tab configuration in a first latch embodiment of the present invention.

FIG. 1A is an end view of the latch of FIG. 1.

FIG. 1B is a side view of the latch of FIG. 1.

FIG. 2 is an exploded view of the component parts of the first embodiment of FIG. 1.

FIG. 3 is a perspective view of the right-hand side of the window frame of a sash window, with an opening in the frame to receive the latch of FIG. 1.

FIG. 3A is a perspective view of a left-hand embodiment of the latch of FIG. 1 being oriented for installation into the left-hand opening of a sash window frame.

FIG. 3B is a perspective view of the latch of FIG. 4A after being installed in the sash window frame.

FIG. 4 is a front view of the installed latch of FIG. 4B.

FIG. 5 is a top view of the installed latch of FIG. 4B,

FIG. 6 is a side view of the installed latch of FIG. 4B.

FIG. 7A is the perspective view of FIG. 1 being enlarged, and focusing on the multi-tabbed platforms of the present invention.

FIG. 7B is the side view of FIG. 1B being enlarged, and focusing on the multi-tabbed platforms of the present invention.

FIG. 7C is a bottom view of the latch of FIG. 1D.

FIG. 8 is a front view during installation of the latch of FIG. 4A, showing initial deflection of the bridge tabs.

FIG. 8A is the view of FIG. 8 enlarged to show greater detail of the bridge tabs while being deflected during installation of the latch.

FIG. 9 is a front view showing the latch of FIG. 4A installed using the first bridge tab.

FIG. 9A is the view of FIG. 9 enlarged to show greater detail of the engagement of the first bridge tab with the sash window frame.

FIG. 10 is a front view showing subsequent deflection of the bridge tabs during the process of installing the latch of FIG. 9A to make use of the second bridge tab.

FIG. 10A is the view of FIG. 10 enlarged to show greater detail of the bridge tabs while being deflected during installation of the latch.

FIG. 11 is a front view showing the latch of FIG. 10A installed using the second bridge tab.

FIG. 11A is the view of FIG. 11 enlarged to show greater detail of the engagement of the second bridge tab with the sash window frame, and showing initial deflection of the stepped tab.

FIG. 12 is a front view showing continued deflection of the stepped tab during the continued process of installing the latch of FIG. 9A to make use of the notch in the stepped tab.

FIG. 12A is the view of FIG. 10 enlarged to show greater detail of the stepped tabs while being deflected during continued installation of the latch.

FIG. 13 is a front view showing the latch of FIG. 12A installed using the notch in the stepped tab.

FIG. 13A is the view of FIG. 13 enlarged to show greater detail of the engagement of the notch of the stepped tab with the sash window frame.

FIG. 14 is a front view showing the latch of FIG. 13A installed using the front surface of the stepped tab.

FIG. 14A is the view of FIG. 14 enlarged to show greater detail of the engagement of the front surface of the stepped tab with the sash window frame.

FIGS. 15A-15D are the views of FIGS. 9A, 11A, 13A, and 14A arranged together to show the four possible installations for the first embodiment of the latch of FIG. 4A.

FIG. 16 is a bottom view of the first multiple tab configuration in the first embodiment of the latch of FIG. 1.

FIG. 16A is a perspective view of the latch of FIG. 16.

FIG. 17 is a bottom view of a second multiple tab configuration in a second embodiment of the latch of the present invention.

FIG. 17A is a perspective view of the latch of FIG. 17.

FIG. 18 is a bottom view of a third multiple tab configuration in a third embodiment of the latch of the present invention.

FIG. 18A is a perspective view of the latch of FIG. 18.

FIG. 19 is a bottom view of a fourth multiple tab configuration in a fourth embodiment of the latch of the present invention.

FIG. 19A is a perspective view of the latch of FIG. 19.

FIG. 20 is a bottom view of a fifth multiple tab configuration in a fifth embodiment of the latch of the present invention.

FIG. 20A is a perspective view of the latch of FIG. 20.

FIG. 21 is a bottom view of a sixth multiple tab configuration in a sixth embodiment of the latch of the present invention.

FIG. 21A is a perspective view of the latch of FIG. 21.

FIG. 22 is a bottom view of a seventh multiple tab configuration in a seventh embodiment of the latch of the present invention.

FIG. 22A is a perspective view of the latch of FIG. 22.

FIG. 23 is a bottom view of a eighth multiple tab configuration in a eighth embodiment of the latch of the present invention.

FIG. 23A is a perspective view of the latch of FIG. 23.

FIG. 24 is a bottom view of a ninth multiple tab configuration in a ninth embodiment of the latch of the present invention.

FIG. 24A is a perspective view of the latch of FIG. 24.

FIG. 25 is a bottom view of a tenth multiple tab configuration in a tenth embodiment of the latch of the present invention.

FIG. 25A is a perspective view of the latch of FIG. 25.

FIG. 26 is a bottom view of a eleventh multiple tab configuration in an eleventh embodiment of the latch of the present invention.

FIG. 26A is a perspective view of the latch of FIG. 26.

FIG. 27 is a bottom view of a twelfth multiple tab configuration in a twelfth embodiment of the latch of the present invention.

FIG. 27A is a perspective view of the latch of FIG. 27.

FIG. 28 is a bottom view of a thirteenth multiple tab configuration in a thirteenth embodiment of the latch of the present invention.

FIG. 28A is a perspective view of the latch of FIG. 28.

FIG. 29 is a bottom view of a fourteenth multiple tab configuration in a fourteenth embodiment of the latch of the present invention.

FIG. 29A is a perspective view of the latch of FIG. 29.

FIG. 30 is a bottom view of a fifteenth multiple tab configuration in a fifteenth embodiment of the latch of the present invention.

FIG. 30A is a perspective view of the latch of FIG. 30.

FIG. 31 is a bottom view of a sixteenth multiple tab configuration in a sixteenth embodiment of the latch of the present invention.

FIG. 31A is a perspective view of the latch of FIG. 31.

FIG. 32 is a bottom view of a seventeenth multiple tab configuration in a seventeenth embodiment of the latch of the present invention.

FIG. 32A is a perspective view of the latch of FIG. 32.

FIG. 33 is a bottom view of a eighteenth multiple tab configuration in an eighteenth embodiment of the latch of the present invention.

FIG. 33A is a perspective view of the latch of FIG. 33.

FIG. 34 is a bottom view of a nineteenth multiple tab configuration in a nineteenth embodiment of the latch of the present invention.

FIG. 34A is a perspective view of the latch of FIG. 34.

FIG. 35 is a bottom view of a twentieth multiple tab configuration in a twentieth embodiment of the latch of the present invention.

FIG. 35A is a perspective view of the latch of FIG. 35.

FIG. 36 is a perspective view of the right-hand latch of FIG. 1 installed in the sash window frame, and with the latch tongue having a first embodiment of an engagement surface being rippled.

FIG. 36A is the perspective view of FIG. 35 being enlarged to show the latch tongue.

FIG. 37 is a perspective view of the latch and sash window frame of FIG. 35 installed in a master window frame, and with the latch tongue engaging the master window frame.

FIG. 37A is the perspective view of FIG. 36 being enlarged to show the latch tongue engaging the master window frame.

FIG. 38 is a top view of the latch and sash window frame of FIG. 36 shown installed in a master window frame, and with the latch tongue engaging the master window frame.

FIG. 38A is a cross-sectional view of the latch and sash window frame as installed in a master window frame according to FIG. 38.

FIG. 38B is the top view of FIG. 38 being enlarged to show the ripples of the latch tongue engaging the master window frame.

FIG. 39 is the top view of the FIG. 38, but shown with twisting of the latch and latch tongue.

FIG. 39A is the cross-sectional view of FIG. 38A, but shown with twisting of the latch and latch tongue.

FIG. 39B is the top view of FIG. 38B, but shown with twisting of the latch and latch tongue.

FIG. 39C is the cross-sectional view of FIG. 38A, but enlarged to show the twisting of the latch and latch tongue.

FIG. 40 is the perspective view of FIG. 36, but with an alternate embodiment of the latch tongue being shown.

FIG. 40A is the perspective view of FIG. 40 being enlarged to show the alternate embodiment of the latch tongue.

FIG. 41 is the latch and sash window frame of FIG. 40 installed in a master window frame, and with the alternate embodiment latch tongue engaging the master window frame.

FIG. 41A is the perspective view of FIG. 41 being enlarged to show the alternate embodiment latch tongue.

FIG. 42 is a top view of the latch and sash window frame of FIG. 41 shown installed in a master window frame, and with the alternate embodiment latch tongue engaging the master window frame.

FIG. 42A is a cross-sectional view of the latch and sash window frame as installed in a master window frame according to FIG. 42.

FIG. 42B is the top view of FIG. 42 being enlarged to show the alternate embodiment of the latch tongue engaging the master window frame.

FIG. 43 is a top view of the FIG. 42, but shown with twisting of the latch and latch tongue.

FIG. 43A is a cross-sectional view FIG. 42A, but shown with twisting of the latch and latch tongue.

FIG. 43B is the top view of FIG. 42B, but shown with twisting of the latch and latch tongue.

FIG. 43C is the cross-sectional view FIG. 43A, but enlarged to show the twisting of the latch and latch tongue.

### DETAILED DESCRIPTION OF THE INVENTION

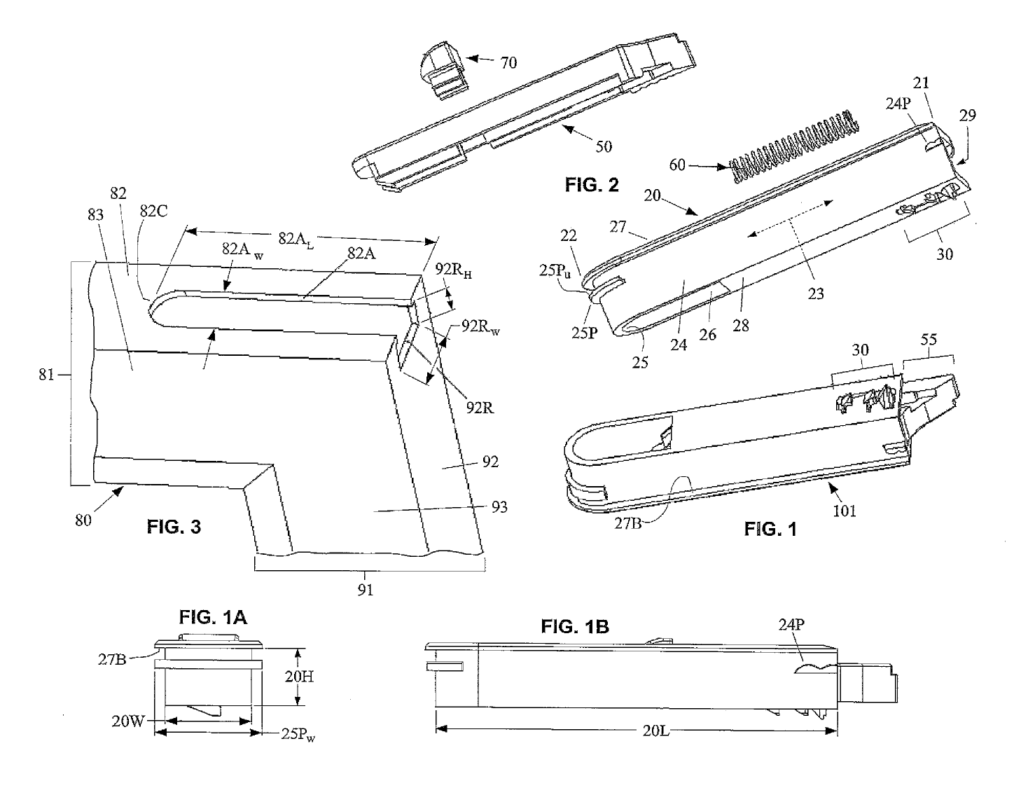

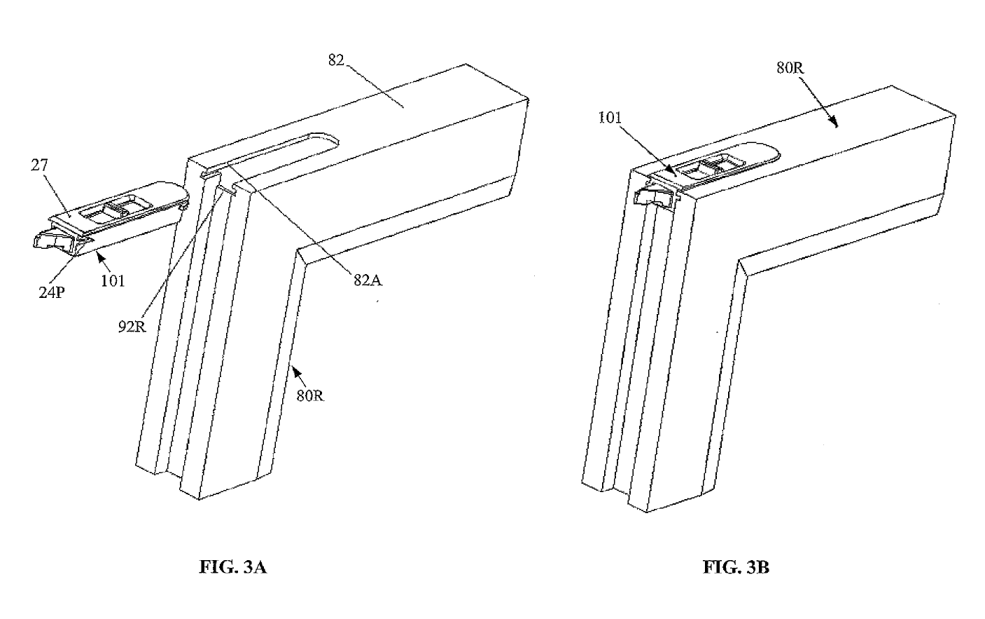

FIG. 1 shows a first embodiment of the latch assembly 101 of the present invention, the components of which are shown in an exploded view in FIG. 2. The component parts of the latch 101 include a housing 20, a latch bolt 50, biasing spring 60, and an optional actuation button 70. Assembly of those parts together may generally be in accordance with our co-pending patent application Ser. No. 12/228,887, the disclosures of which are incorporated herein by reference. In general, the latch bolt 50 and biasing spring 60 may be received in an opening 29 in the housing, with the spring biasing the latch bolt from a first position, in which it is partially or completely withdrawn into the housing, to be in a second position, in which a portion of the latch bolt (nose portion 55, see FIG. 1) protrudes beyond the housing for engagement with a master window frame 200 (see FIG. 37), when the latch is installed in a sash window frame. The spring 60 may be configured to limit the outward travel of the latch bolt 50 from the housing 20, or a stop may be used to limit such travel. The stop may be on a portion of the latch bolt, which may contact a portion of the housing, or the stop may be on a portion of the button that may be fixedly secured to the latch bolt.

The housing 20 may comprise individual wall members that may be assembled together using mechanical fasteners, adhesive bonding, welding, etc., to create the housing 20. As seen in FIG. 2, housing 20 may have a first end 21 and a second end 22, and may comprise a unitary wall formed into an appropriate elongated shape, which may be hollow. The unitary wall may have a first side wall portion 24 that may transition into a second side wall portion 26 using a semi-circular wall portion 25, with the first side, second side, and semi-circular transition being connected by a top wall portion 27, and a bottom wall portion 28. The first end 21 of housing 20 may have top wall portion 27, bottom wall portion 28, first side wall portion 24, and second side wall portion 26 terminate at a common plane, and form an opening 29 into a cavity 23.

The top wall portion 27 may preferably overhang the first side 24, second side 26 and semi-circular transition 25 by a small distance, being sufficient to permit installation of the latch 10 into the sash window frame, as discussed hereinafter. The overhanging portion of top wall 27 may, but need not, have a generally flat bottom surface 27B (FIGS. 1 and 1A). In addition, the first side portion 24 and second side portion 26 may each have a protrusion 24P, 26P, protruding therefrom, respectively, and each of them may be formed to have a rectangular cross-section. Other cross-sectional shapes for the protrusion 24P, 27P, may be used, as seen in FIG. 1D, however, the distance to the generally flat bottom surface 27B of top wall portion 27 requires adequate control to permit an acceptable installation of the latch in the sash frame. Use of the alternative cross-sectional shape and effect on installation of the latch of the present invention is discussed later in the paragraphs describing the installation of the latch.

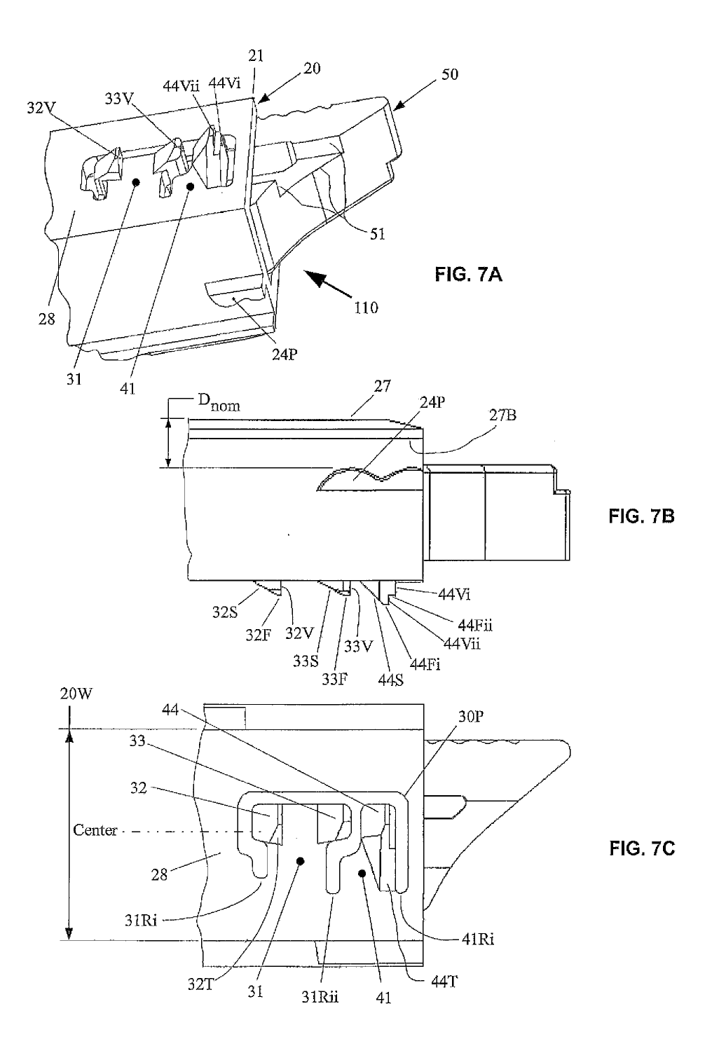

Similarly, the semi-circular wall portion 25 may have an annular protrusion 25P protruding therefrom, and may preferably being formed to have a rectangular cross-section. Also, the protrusions 24P, 25P, and 26P need not be formed using a rectangular cross-section, but may instead only have respective flat upper surfaces 24P_{U}, 25P_{U}, and 26P_{U} that are parallel to the flat lower overhanging surface of the top wall portion 27, to engage the meeting rail of the sash window frame and accommodate installation of the latch therein. Also, the protrusions 24P and 26P may extend the length of the first side portion 24 and second side portion 26, respectively, and interconnect with protrusion 25P of the semi-circular transition 25 to form a unitary protruding member. However, as discussed later, where the alternative (undulating) cross-sectional shape of FIG. 7B is used for protrusions 24P and 25P, the protrusions 24P and 25P preferably do not interconnect with protrusion 25P.

One embodiment of a sash window frame 80, as seen in perspective in FIG. 3, may be formed of a meeting rail 81 and a stile 91. The meeting rail 81 may comprise at least a horizontal top flange 82, and lateral support flanges 83 and 84, while the stile 91 may similarly comprise at least a vertical side flange 92 and lateral support flanges 93 and 94. The horizontal top flange 82 of meeting rail 81 may converge with the vertical side flange 92 of stile 91 to form a visible edge, while the convergence of the lateral support flanges for both the meeting rail 81 and the stile 91 may converge indistinguishably and thus may appear as a unitary member.

The stile 91 may have a rectangular opening 92R formed therein and may be centered upon the vertical side flange 92 and begin immediately below the thickness of the horizontal top flange 82 of meeting rail 81. The opening 92R may be formed having a width 92R_{W} being sized to provide a slight clearance with the width 25P_{W} of the latch housing 20 (FIG. 1A) formed by the side surfaces of the housing's side wall protrusions 24P/26P and/or the protrusion 25P of the semi-circular transition 25. The opening 92R may also be formed having a height 92R_{H} being sized to provide a slight clearance with the height 20H of the housing 20, formed by the exterior surface of the housing's bottom wall portion 28 and the bottom surface 27B of the top wall portion (top plate) 27. Alternatively, as seen in FIG. 6, an opening 92C in stile 91 may be contoured to precisely match both the profile of the housing walls and protrusions (but not the shaped tabs, discussed hereinafter).

The horizontal top flange 82 of meeting rail 81 may have an opening therein as well, which may preferably be arch-shaped opening 82A. Arch-shaped opening 82A may be formed in meeting rail 81 to be generally centered upon the horizontal top flange 82, and to start at the end of the rail proximate to rectangular opening 92R and end in a semi-circular end surface 92C. The opening 82A may be formed having a width 82A_{W} being sized to provide a slight clearance with the width 20W of the housing 20, being formed by the exterior surfaces of the housing's first side wall portion 24 and second side wall portion 26. The opening 82A may also be formed having a length 82A_{L} be sized to be approximately equal to, or slightly less than, the length 20L of the housing 20 (FIG. 1B).

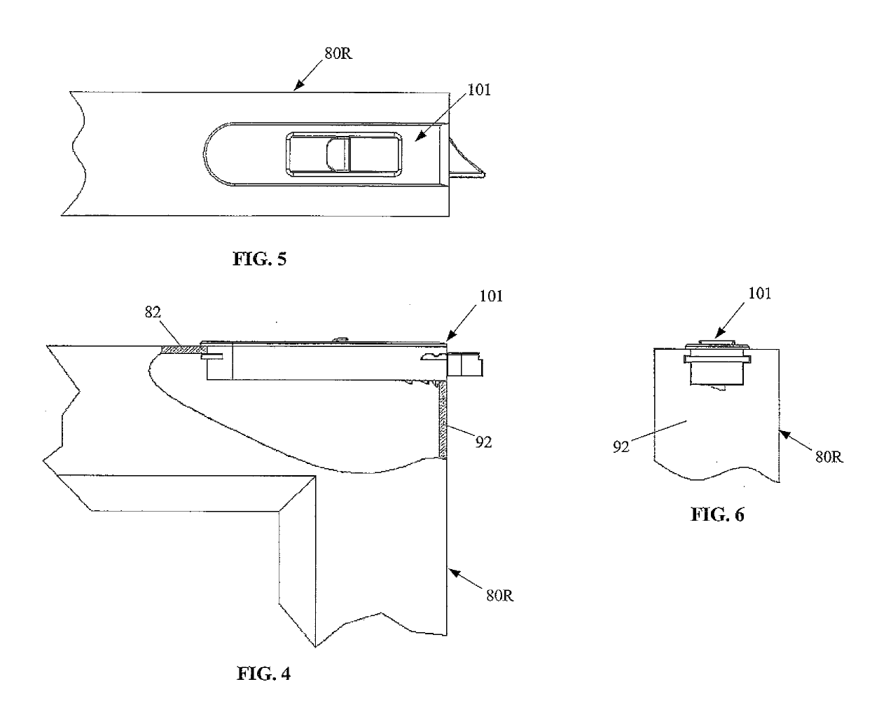

The sliding installation process for the latch 101 may be seen in FIG. 3A, just as the latch is aligned to be fed into the opening of another style sash frame 80A, and also in FIG. 3B, where the latch has been successfully installed. Three views of the latch 110, as installed into the sash frame 80 are shown in FIGS. 4-6. The present invention discloses a sash window tilt latch with a means for accommodating varying set-back distances associated with varying cross-sectional arrangements of different sash frames, such as, for sash frame 80R of FIG. 3A, where there is a recess in the stile that is not present in the stile of sash frame 80 of FIG. 3. The means of accommodating diverse cross-sectional arrangements of the different sash frames available is found in a first embodiment of the multi-tabbed platform feature 30, as seen in FIGS. 1 and 2, and as enlarged in the view of FIGS. 7A-7C.

The multi-tabbed platform feature 30 may comprise one or more platforms having one or more tabs integrally formed thereon, and in a one embodiment, it may comprise platforms 31 and 41. In the embodiment shown in FIG. 7A for latch 110, the platforms 31 and 41 may be formed through an injection molding process that may have been used to initially manufacture the housing 20, where the part is a plastic part, or may be formed in a similar manner if the housing is a cast metal part. The periphery of the platforms may preferably be carefully controlled to provide the desired flexibility and resilience. Where the level of accuracy needed to for the peripheral opening may exceed the limits of such forming processes, the opening may otherwise be created using a secondary manufacturing operation. One means of piercing the bottom wall portion 28 and of routing a contoured periphery 30P to form the platforms 31 and 41 may be through the use of laser cutting.

Irrespective of the manufacturing means utilized for forming the requisite periphery to create the platforms, the contoured periphery 30P may be formed to have an opening within the bottom wall portion 28 that may begin and end at the same place. Thus, the periphery 30P, in one embodiment, may preferably route out what essentially forms a “T”-shaped platform 31, and an “L”-shaped platform 41 (FIG. 7C). Other routed geometric shapes may also produce satisfactory results in accordance with principles of the current invention. The routing may be such that it produces a greater amount of clearance (and possibly a small straight edge rather than curved edges) at the roots of the “T” shape, 31Rᵢ/31Rᵢᵢ, and at the base of the “L” shape, 31Rᵢᵢ/41Rᵢ, than at the sides or top of those geometric shapes, as the this may permit the top of the “T” and corresponding top upstanding portion of the “L” shape to appropriately flex, as described hereinafter. The degree of flexibility may also be affected by and deliberately adjusted through changes to the nominal thickness utilized for the bottom wall section 28, but must nonetheless meet structural strength requirements for the housing. Also, the extent of the base of the “T” shape, between root opening 31Rᵢ and 31Rᵢᵢ, as well as the extent of the base leg of the “L” shape, between root opening 31Rᵢᵢ and 41Rᵢ, may provide a sufficient moment of inertia and other properties for sound structural installation of the latch in the sash frame. Additionally, the routed periphery 30P for latch 101 may be formed so that the top of the “T” and the corresponding top upstanding portion of the “L” shape may preferably be centered on the width 20W of bottom wall portion 28 (FIG. 7C).

Protruding up from the top of the flexible “T”-shaped platform 31 and protruding up from the corresponding top upstanding portion of the flexible “L”-shaped platform 41 may preferably be shaped, structural tabs that are constructed in accordance with the present invention.

The “T”-shaped platform 31 may have a first tab 32 generally disposed toward the inner side of the top of the “T” and a second tab 33 being generally disposed toward the outer side of the top of the “T.” It should be noted that use of the relative term herein of “outer” is with respect to the portion of the latch that may be proximate to the sash stile when the latch is installed therein, and is thus closer to the nose of the latch bolt 50, whereas the term “inner” conversely refers to a position being relatively closer to the end of the latch having the semi-circular wall portion 25 that may, upon latch installation, be contained within the meeting rail of the sash frame.

The first shaped, structural tab 32 may comprise a slanted inner side 32S and a vertical outer side 32V (generally orthogonal to the housing top plate) that may meet at an apex. Alternatively, rather than meeting at a sharp edge, the slanted inner side 32S and vertical outer side 32V may be chamfered so that each may terminate on a flat side 32F, which may be horizontal. (Note that the slanted side 32S may be curved rather than being flat). The lateral portion of the tab being proximate to the leg of the “T” may taper down to the bottom wall portion 28 using a tapered side 32T. Similarly, the second shaped, structural tab 33 may comprise a slanted inner side 335 and a vertical outer side 33V, each of which may terminate on a flat side 33F. The tab 33 may also comprise a tapered side 33S. The first and second shaped structural tabs 32 and 33, more particularly the vertical sides 32F and 33F of the respective tabs, may be separated on the “T”-shaped platform 31 by a discrete distance, which may reflect a distance corresponding to an incrementally different sash frame cross-sectional arrangement (e.g., a slightly/moderately/greatly recessed rail-stile sash frame or non-recessed frame).

The “L”-shaped platform 32 may have a single tab 44 that also may comprise a slanted inner side 44S and a vertical outer side 44Vi, each of which may terminate on a flat side 44Fi. A tapered side 44T on tab 44 may be more extensive than for the tapered sides 32S and 33S of tabs 32 and 33. The tab 44 may generally span the entire top of the “T,” and may therefore be somewhat larger than tabs 32 and 33 of the “T” platform, as it may also include a notch creating a second vertical surface 44Vii and a second flat/horizontal surface 44Fii, which may be usable for installation of the latch on a sash window frame having a very small or a zero set-back distance.

The vertical side 33F of tab 33 may be separated by a smaller distance than the distance between vertical sides 32F and 33F of tabs 32 and 33, and also the distance between vertical outer side 44V and the second vertical side surface 44Vii may be separated by an even smaller distance. These smaller distances, where incorporated into the latch configuration, may be used to more finely tune the depth of the installation of the latch into the sash window frame's meeting rail, as seen in the following discussion.

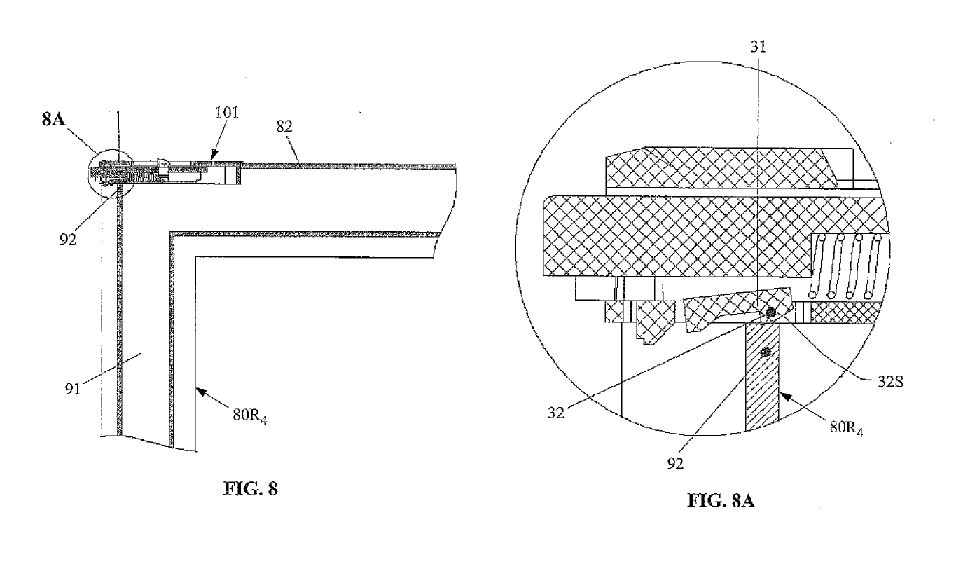

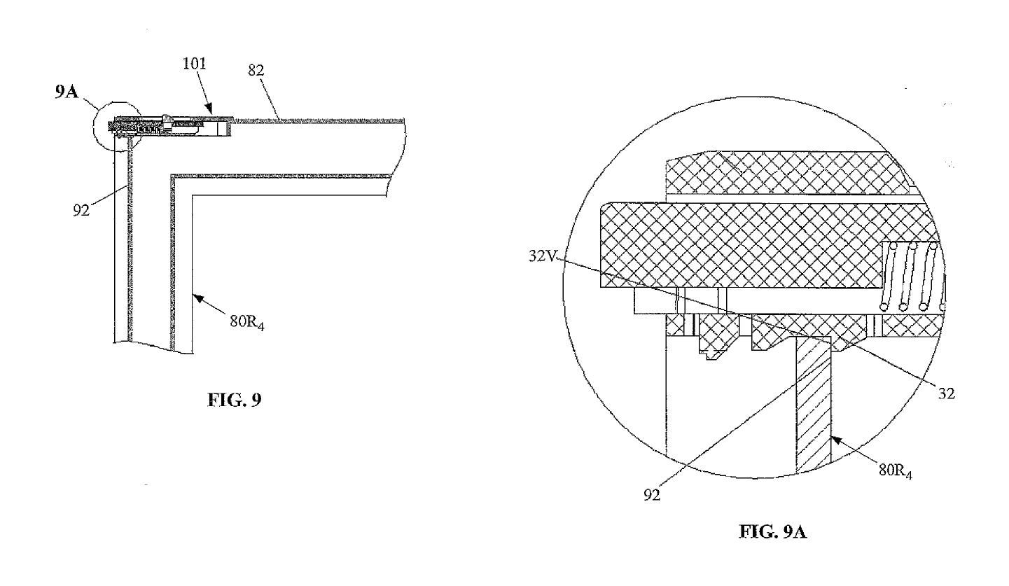

FIG. 8 shows the process of installing the latch 101 into sash frame 80R₄, which has a significantly sized recess in the stile of the frame. While sliding the latch housing through opening 92C/92R of the sash frame 80R₄, the slanted inner side 32S of the first tab 32 initially makes contact with the vertical side flange 92 of the frame, which causes the inner side of the “T” platform 31 to deflect upwardly (into the housing cavity). This upward elastic deflection of the associated bottom wall section 28 may be accommodated by an elongated recess 51 in the bottom of the latch bolt 20, as seen in FIG. 7A. Continued sliding movement of the latch 101 into the stile opening 92C/92R may result in the semi-circular wall portion 25 of housing 20 of latch 101 coming into close proximity to or actually contacting semi-circular end surface 92C of arch-shaped opening 82A in meeting rail 81, just as the “T” platform 31 is restored back down to its normal un-deflected position so that the vertical outer side 32V of tab 32 engages the inner surface of the vertical side flange 92 of stile 91 (FIG. 9A). This engagement between semi-circular wall portion 25 of housing 20 of latch 101 with semi-circular end surface 92C of arch-shaped opening 82A in horizontal top flange 82 of meeting rail 81, and between the vertical outer side 32V of tab 32 with the inner surface of the vertical side flange 92 of stile 91, serves to positively retain the latch 101 within the meeting rail of the sash frame. In this manner, the latch is installed so that its engagement with the sash frame is at a set-back distance from the end of the frame necessitated by the depth of the recess in the stile (the particular cross-sectional of that sash frame).

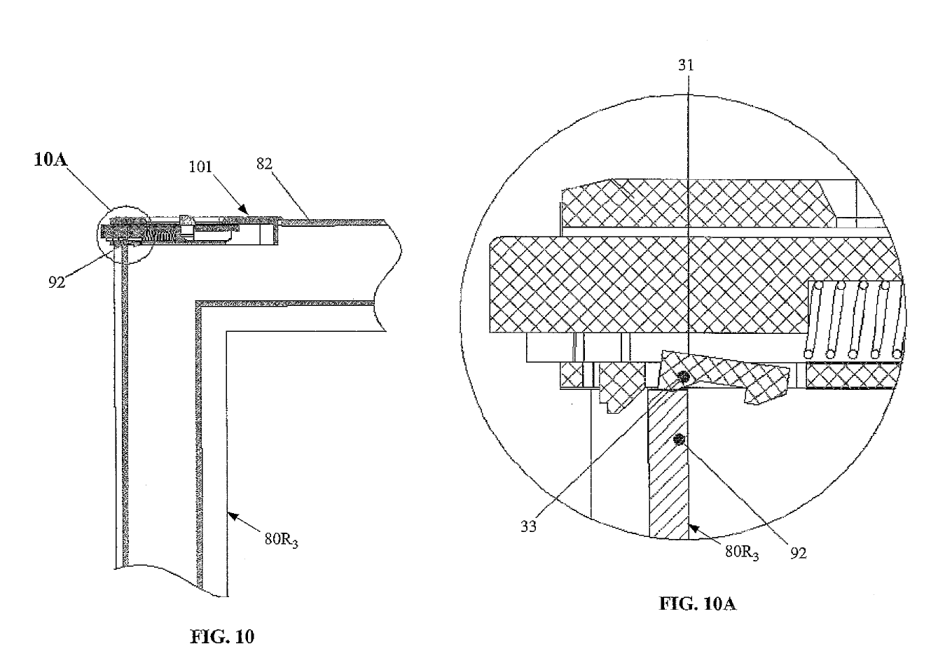

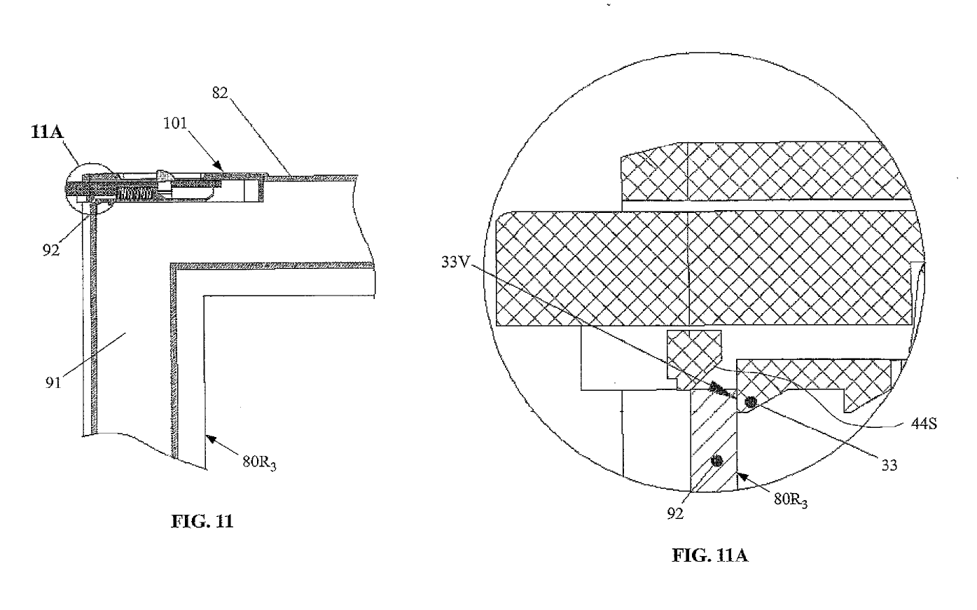

For installation of latch 101 into a sash frame having a slightly smaller recess in the stile (compare frame 80R₄ in FIG. 9A with frame 80R₃ in FIG. 10A), the innermost latch tab would make contact with vertical side flange 92 of stile 91 earlier, as seen in FIG. 10A, and with the slanted inner side 33S of the second tab 33 subsequently making contact with the vertical side flange 92 of the frame 80R₃. This contact then causes the outer side of the “T” platform 31 to deflect upwardly. (Note, where the thickness of bottom wall section 28 of the housing 20 is greater, it is possible for both tabs to more or less deflect upward at the same time, i.e., less torsional deformation, though with the corresponding deflection at each tab still being to slightly different amounts). With a properly sized top opening 82A₃ in frame 80R₃, the latch 110 would be positively secured in the meeting rail of the sash frame (FIG. 11A) by engagement between semi-circular wall portion 25 of housing 20 of latch 101 with semi-circular end surface 92C of arch-shaped opening 82A₃ in horizontal top flange 82 of meeting rail 81, and by engagement of the vertical outer side 33V of tab 33 with the inner surface of the vertical side flange 92 of stile 91. Note that for the separation distance utilized on latch 101 between the tab 44 of the “L”-shaped platform 41 and the tab 33 of the “T”-shaped platform 31, the tab 44, as seen in FIG. 11A, will be deflected upward by, and remain in contact with, the vertical side flange 92 of stile 91, when the latch 101 is secured in the frame 80R₃.

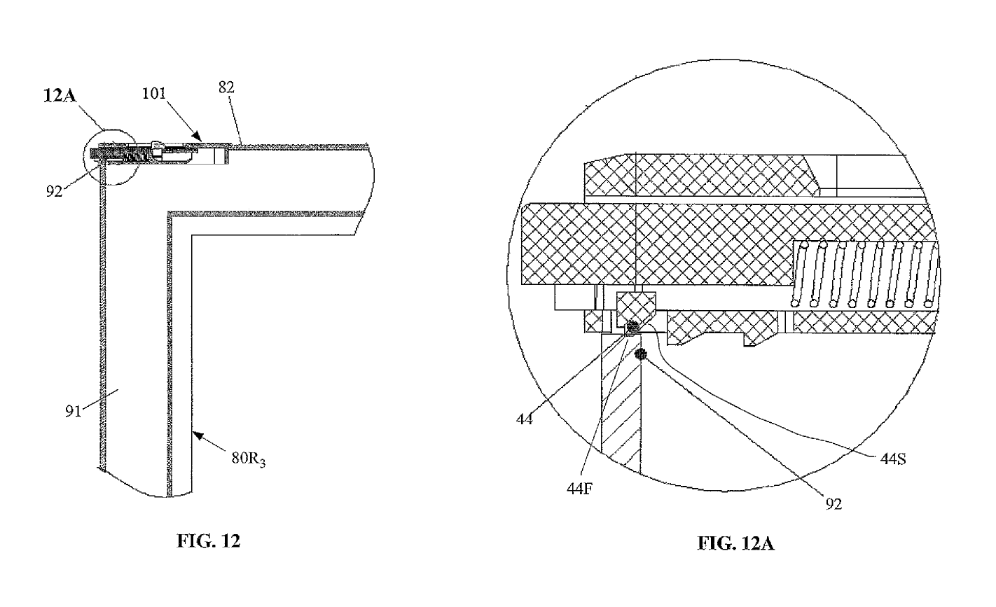

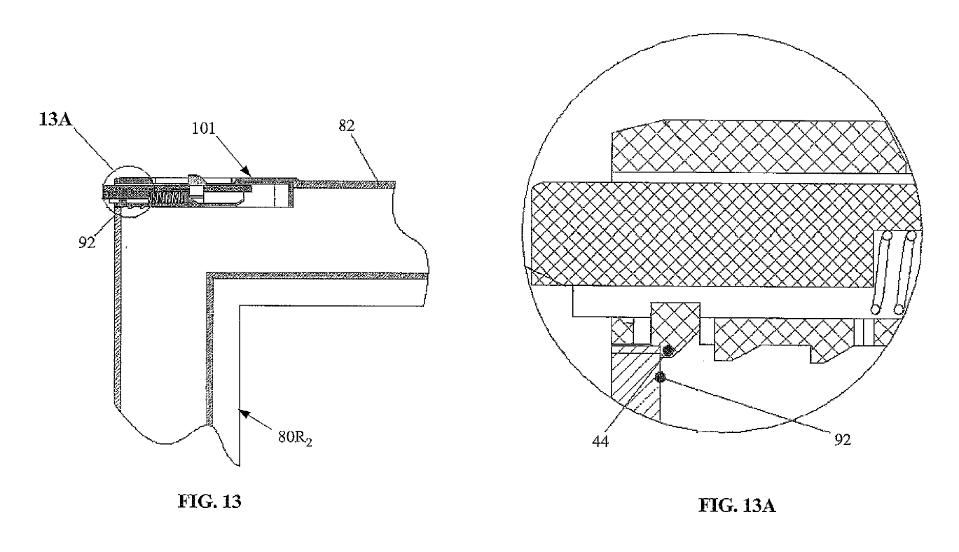

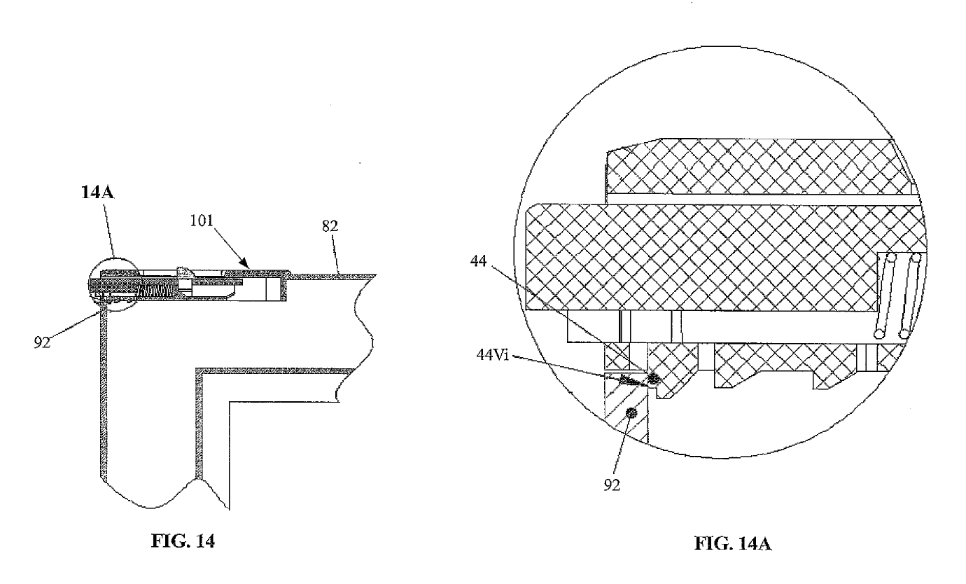

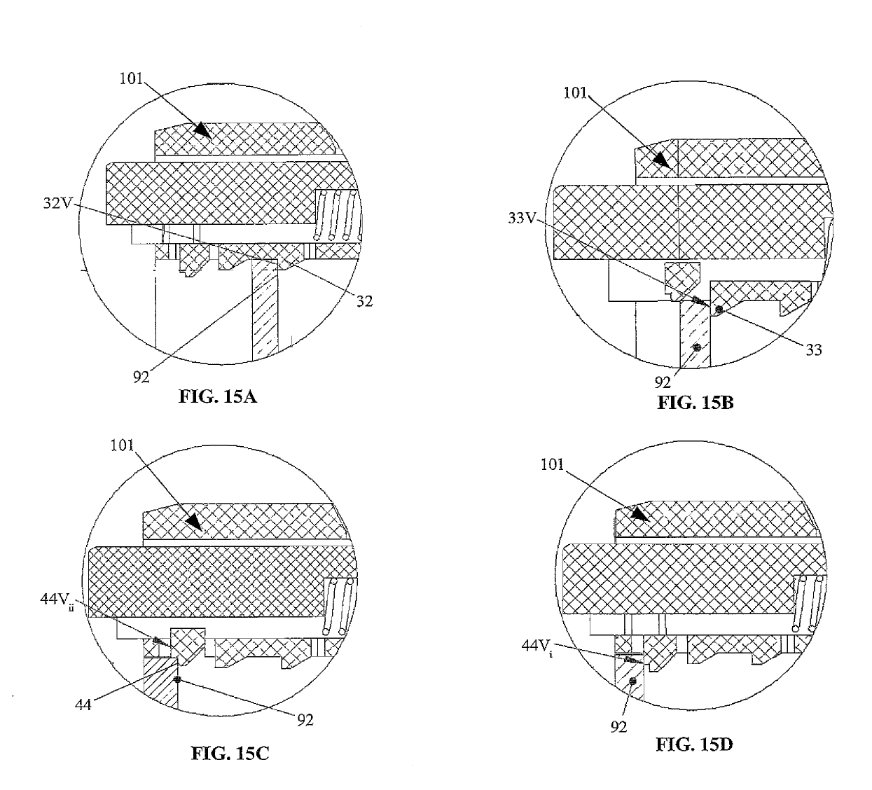

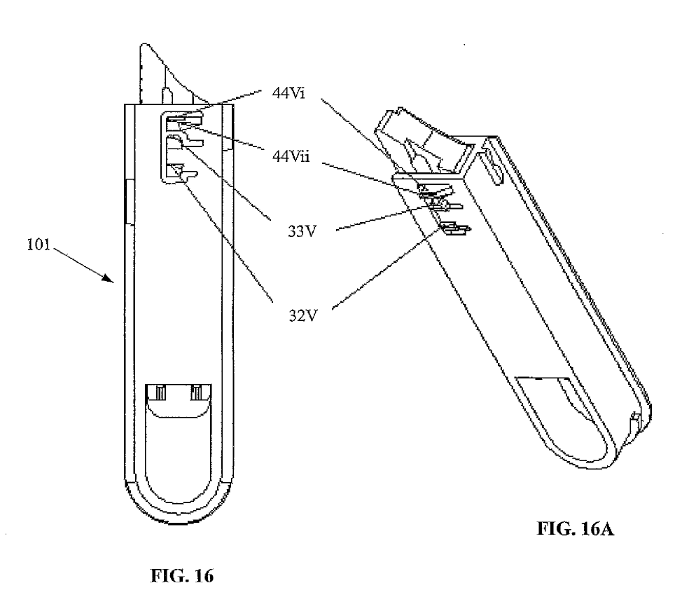

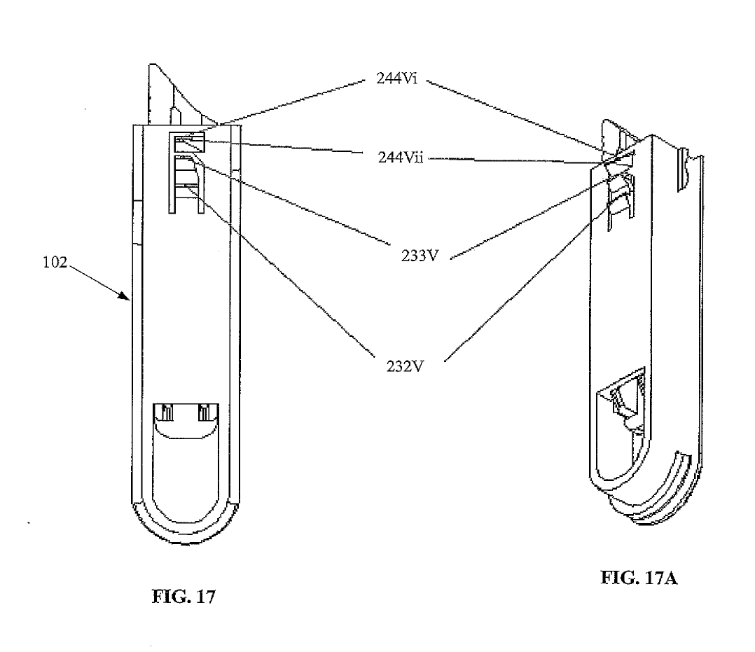

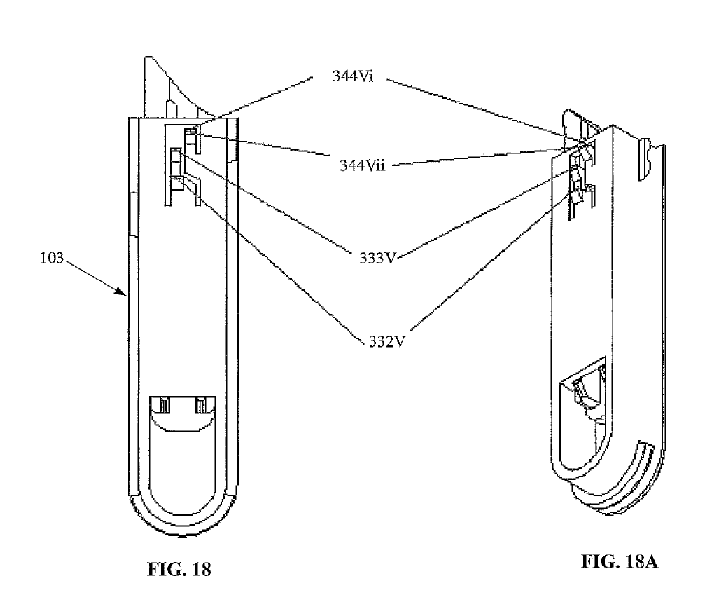

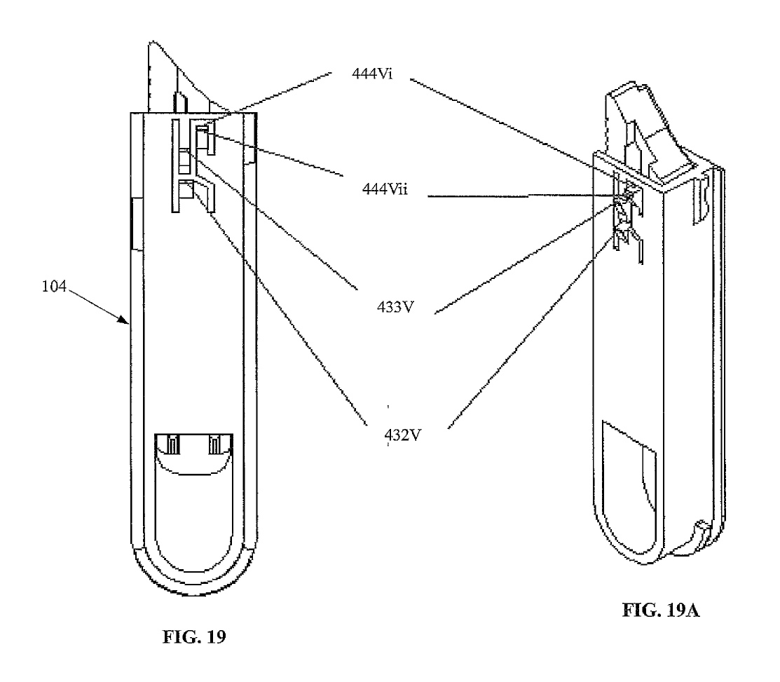

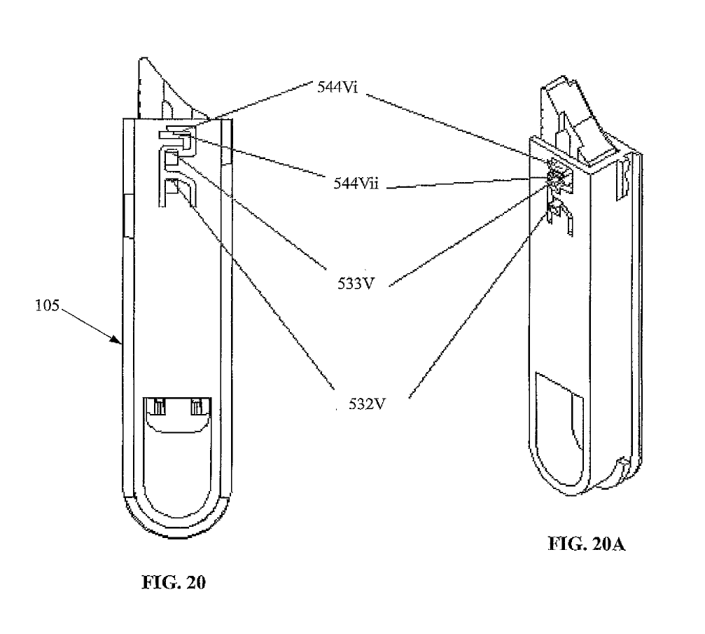

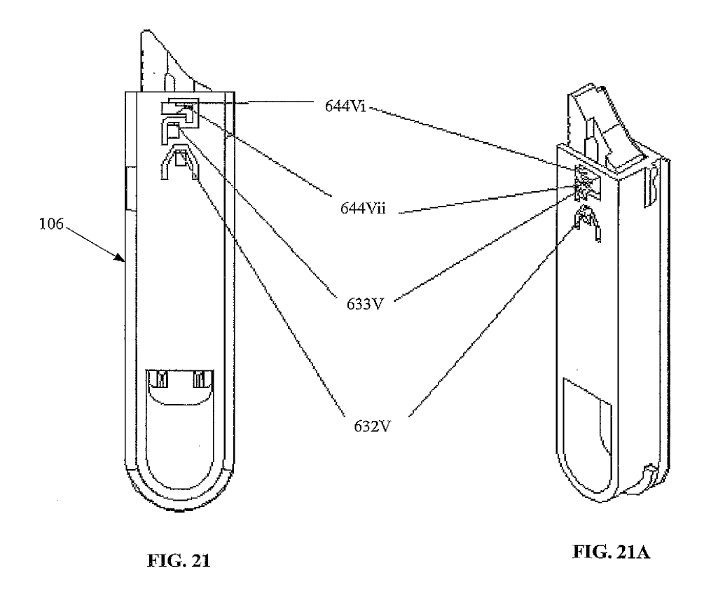

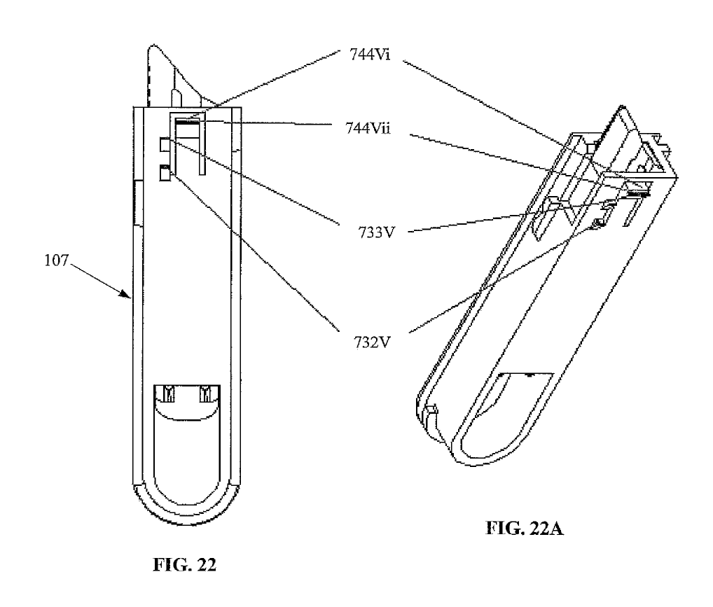

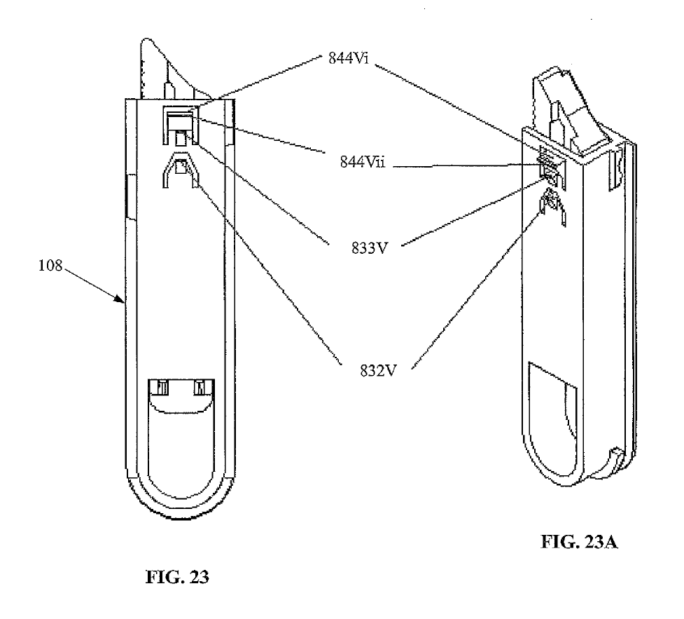

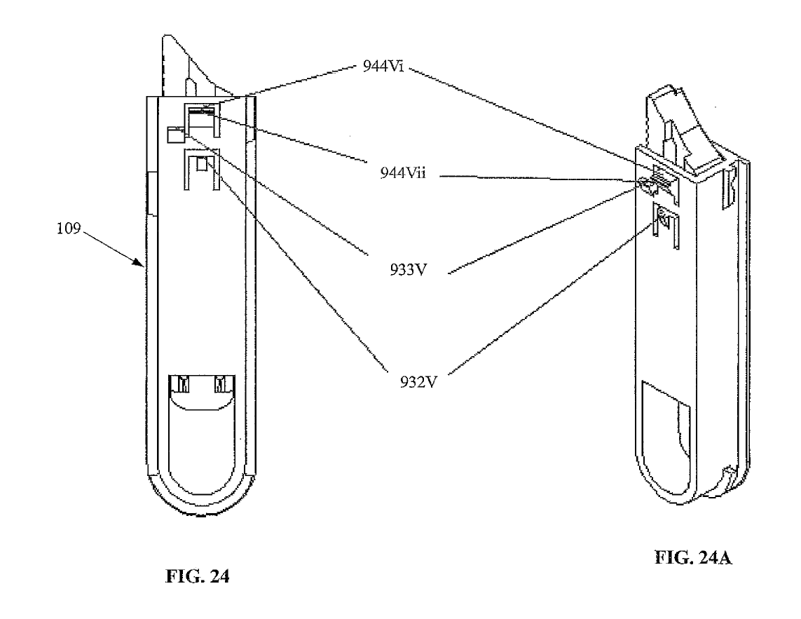

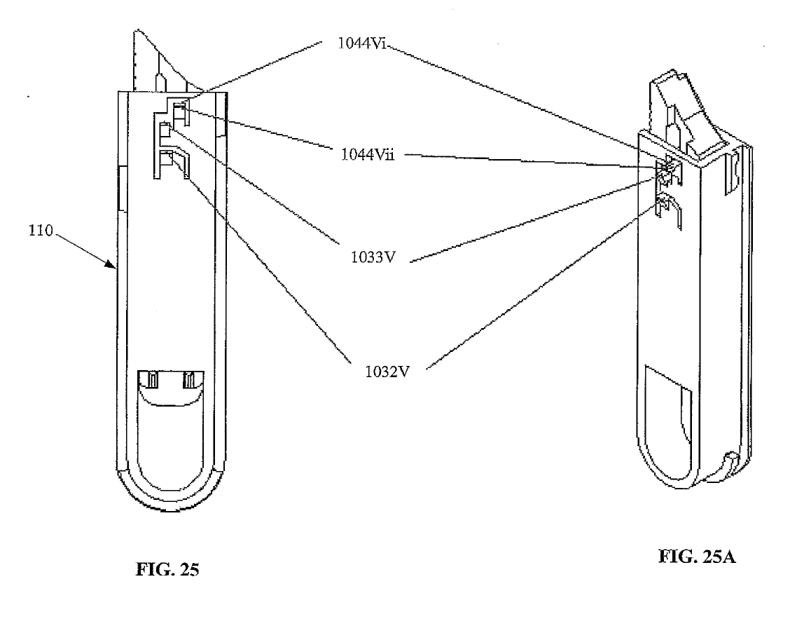

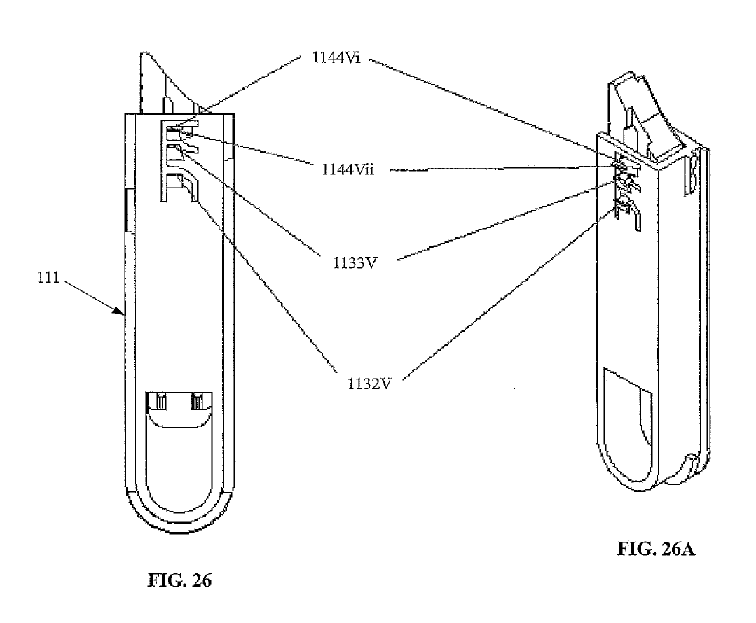

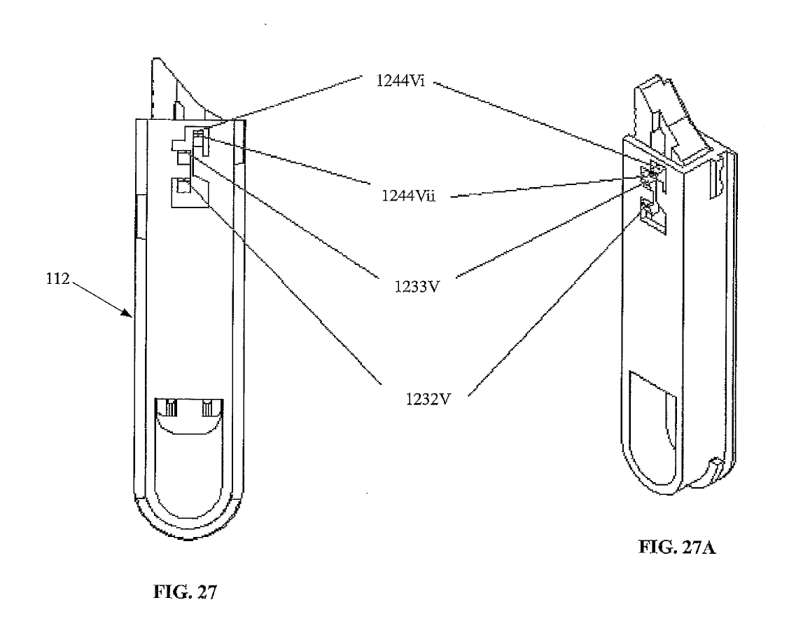

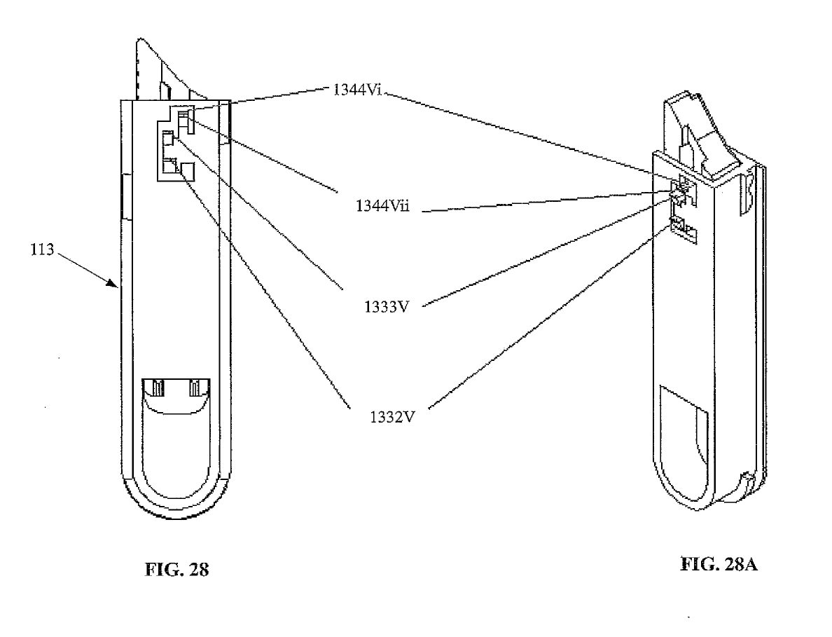

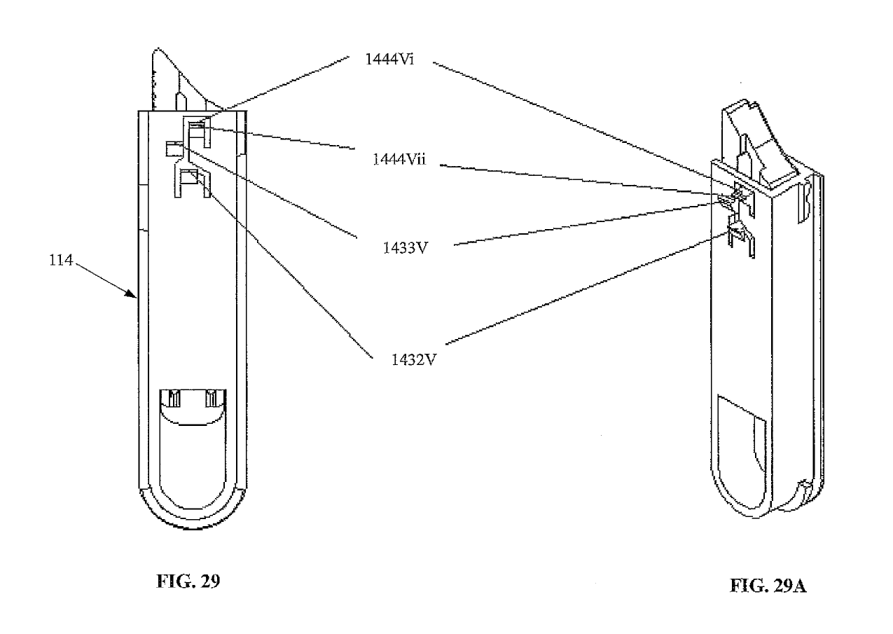

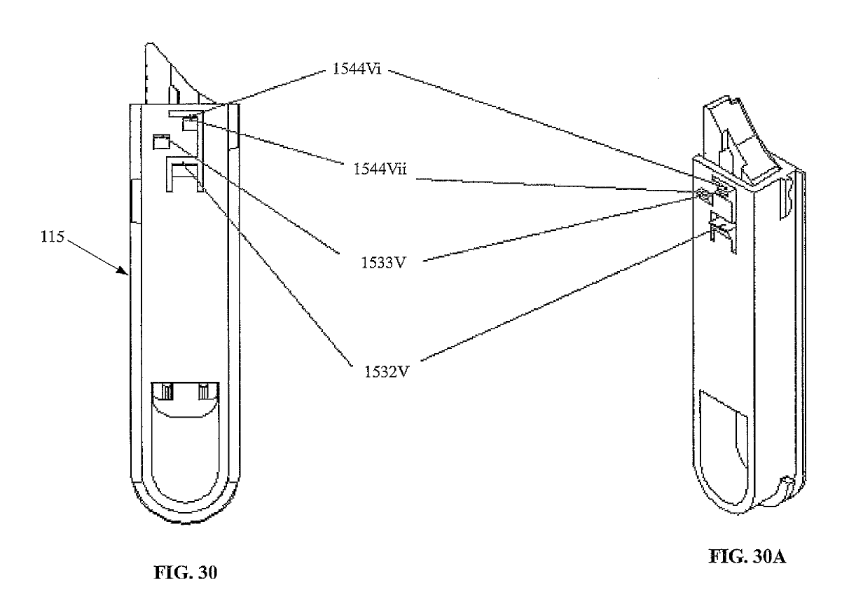

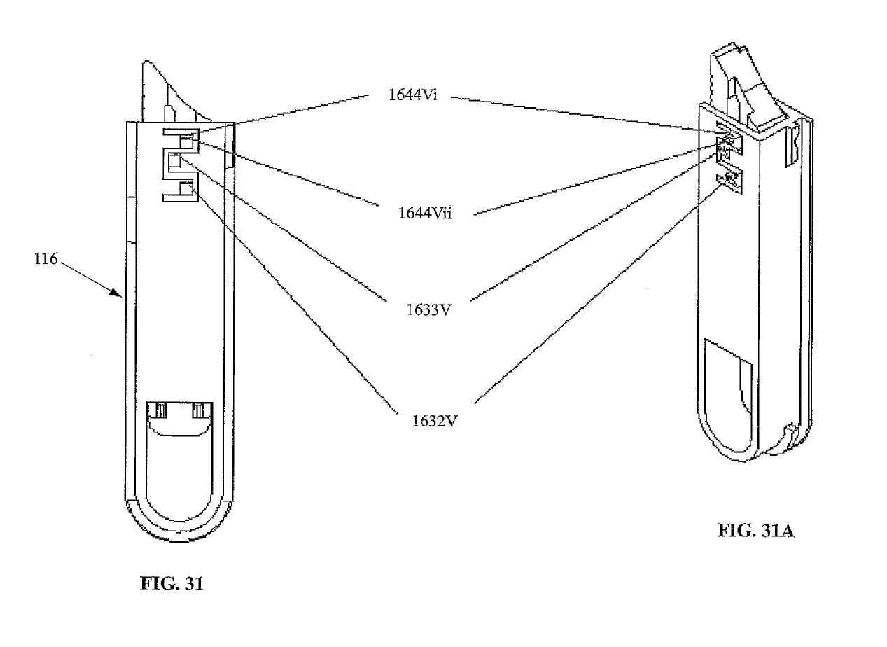

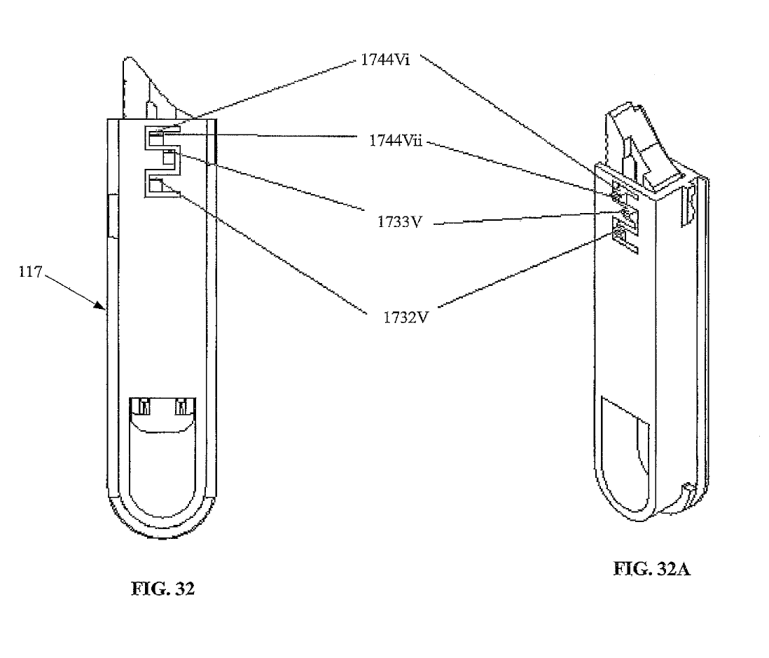

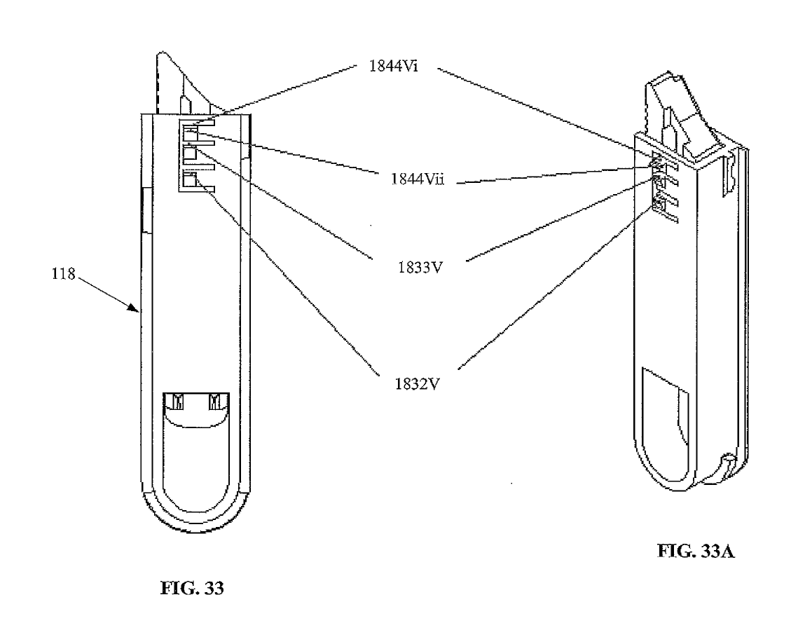

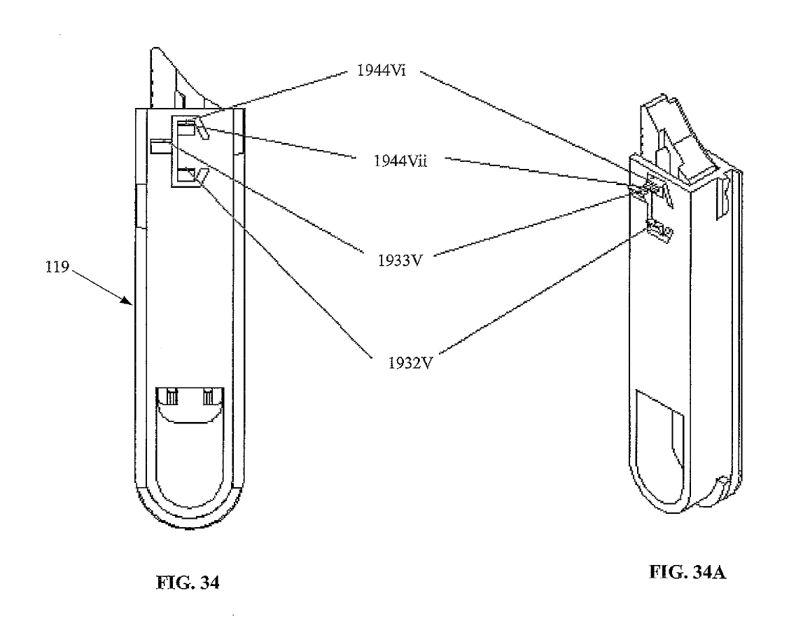

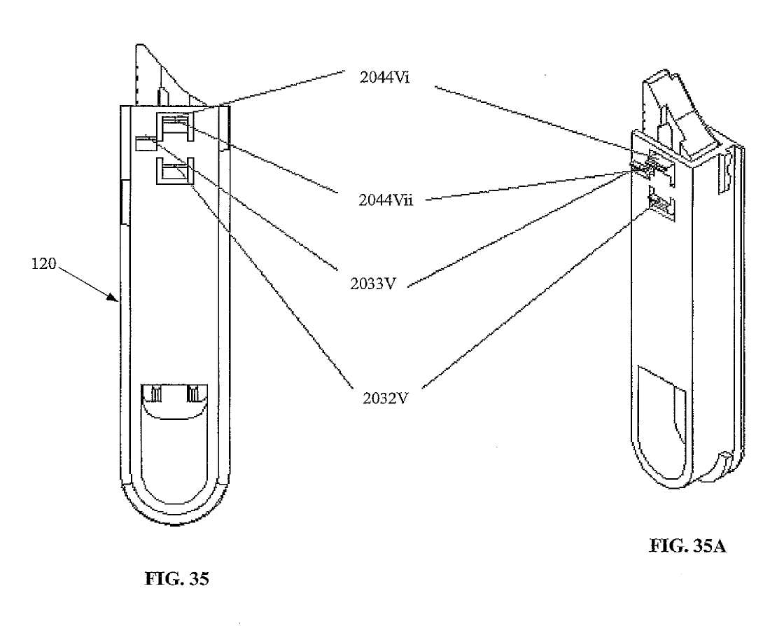

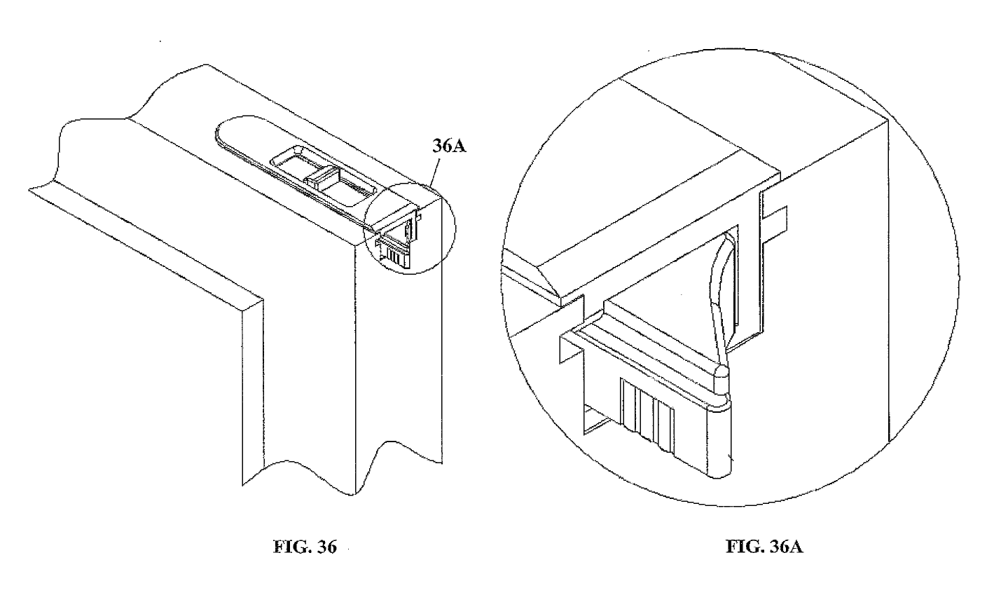

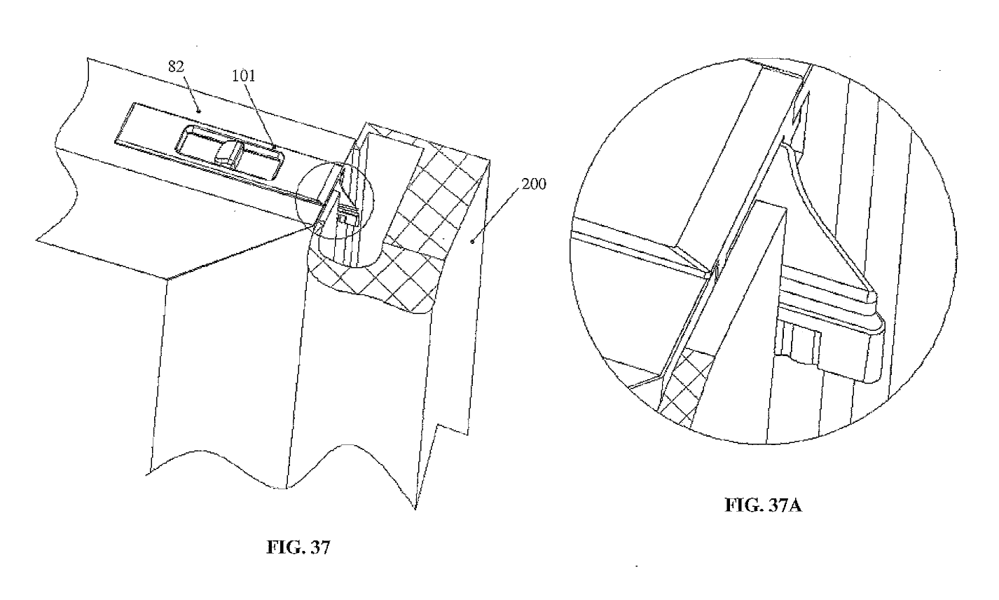

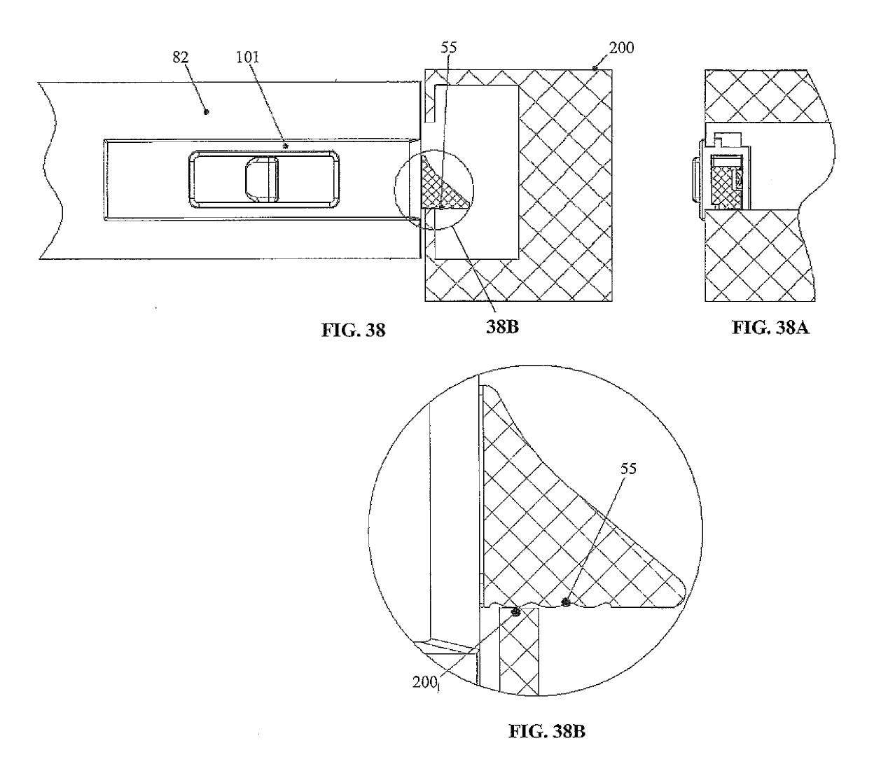

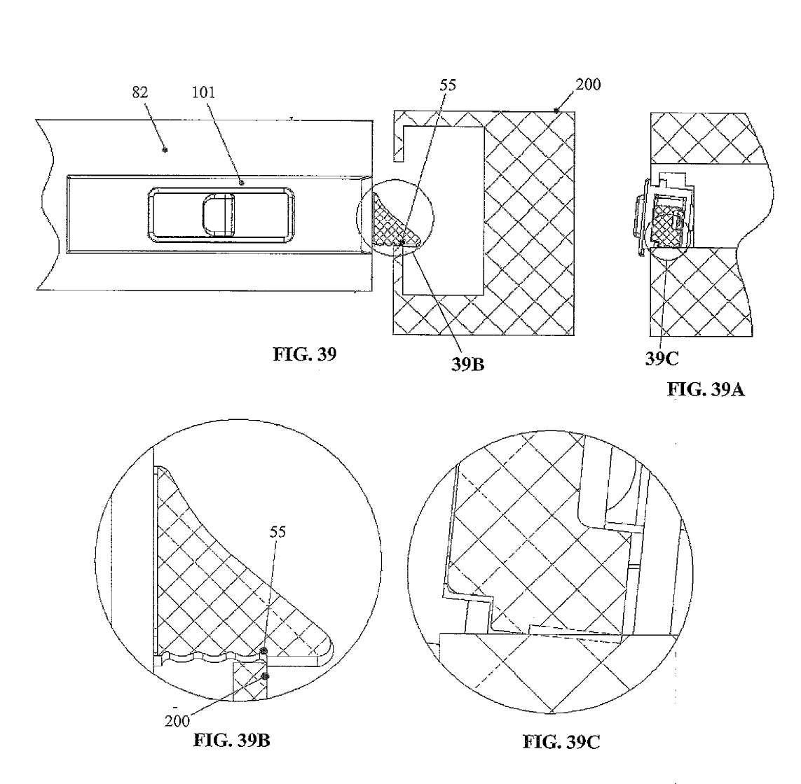

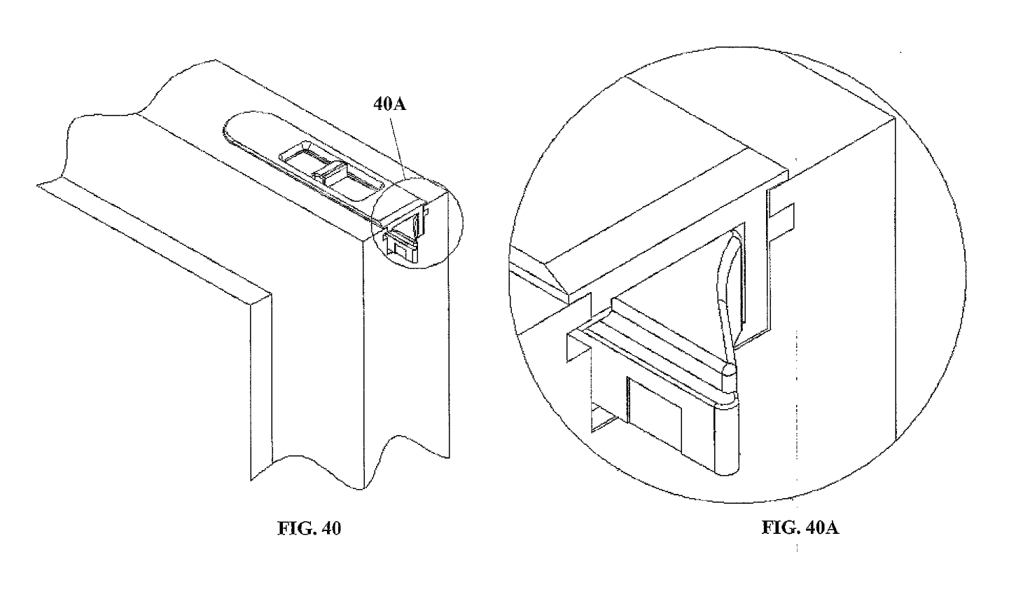

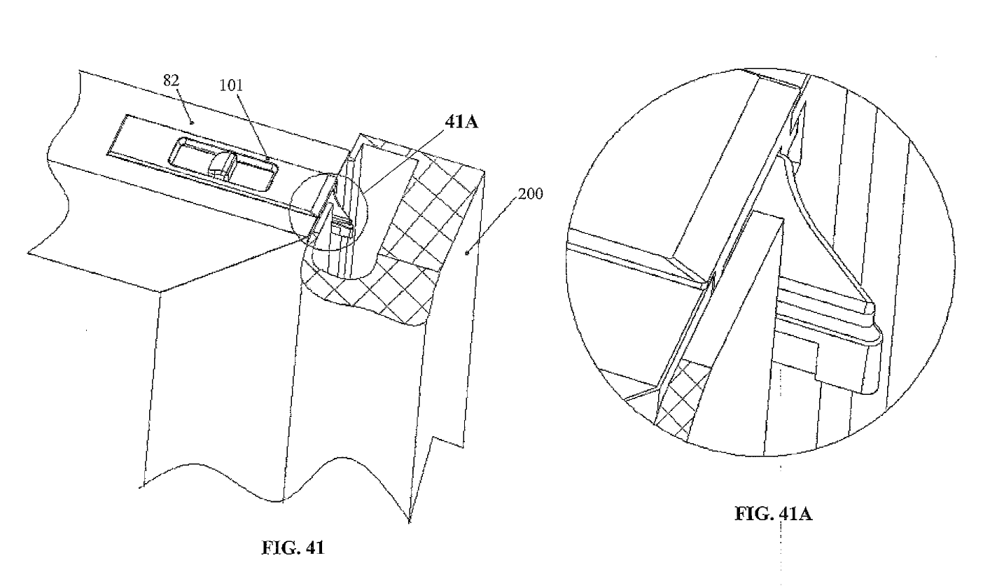

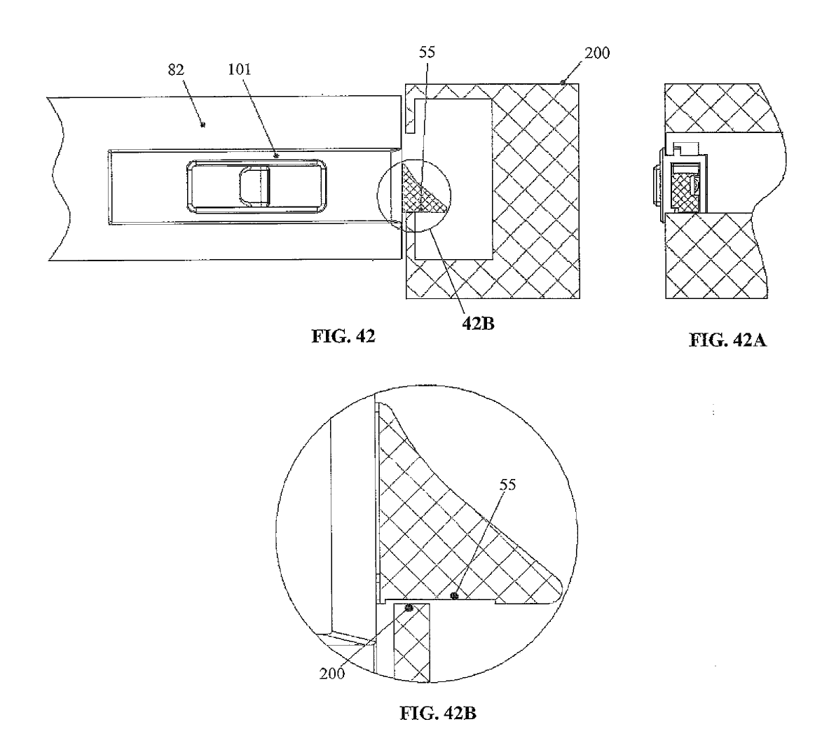

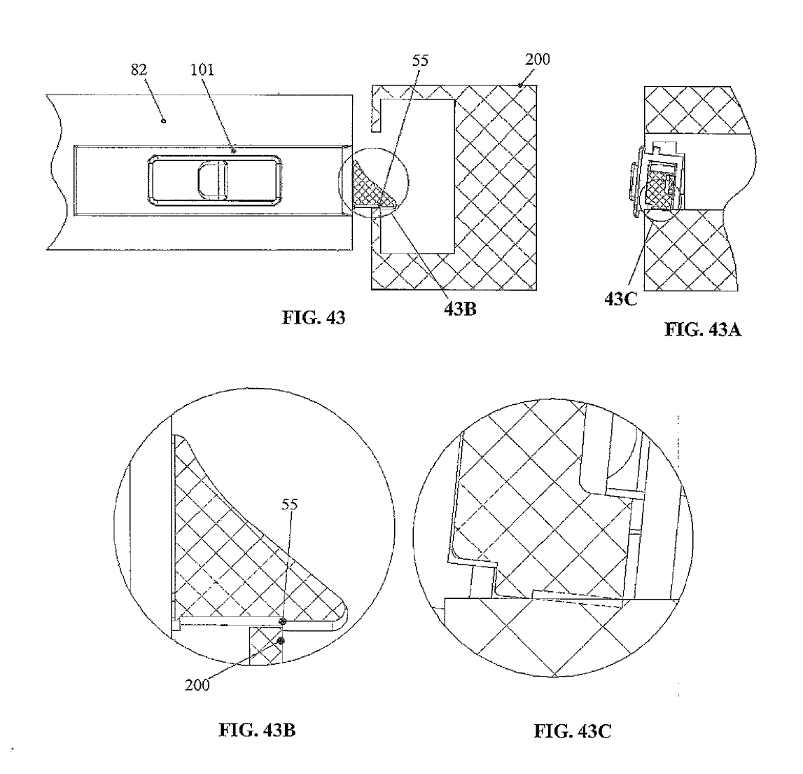

For installation of latch 101 into a sash frame having an even smaller recess in the stile (compare frame 80R₃ in FIG. 11A with frame 80R₂ in FIG. 12A), latch installation would again have otherwise continued, as seen in FIG. 12A, but with the slanted inner side 44S of the tab 44 that was already making contact with the vertical side flange 92 of the frame 80R₃, being deflected upward even further. Then the flat side 44F of tab 44 would be in contact with the vertical side flange 92 until the notch of tab 44 is seated such that the second vertical surface 44Vii and second flat/horizontal surface 44Fii of tab 44 is contacting corresponding orthogonal surfaces of the vertical side flange 92, as seen in FIG. 13A. This may constitute the final installation of latch 101. However, a close tolerance adjustment may be made for the final installed position of latch 101, through use of the vertical outer side 44Vi of tab 44, as seen in FIG. 14A. The four different possible installation positions for the embodiment of latch 101 are shown in the collection of views in FIGS. 15A-15D. It should be noted that in another embodiment, each of the first and second tabs 32 and 33 may also each have a secondary notch therein the same as tab 44, to provide for small installation adjustments as well. Additional embodiments for the formation of the platforms and the tabs thereon are shown in FIGS. 17/17A through FIGS. 35/35A for latches 102-120.

Some of the characteristics of the shaped, structural tabs and other features may be carefully tailored to provide for better performance of the latch of the current invention. For example, the distance that the tabs protrude down away from bottom wall section 28 must be sufficient to ensure that the latch may not easily be unintentionally removed from the stile opening. But if the depth that the shaped structural tabs protrude downward becomes too great, the force necessary for installing the latch may become excessively high for a simple installation by hand, and it may also cause damage to the tabs as a result of the installation contact/deflection with the inner surface of the vertical side flange 92 of stile 91. Also, the amount of play in the fit between the top wall portion 27 of housing 20 and the protrusions 24P/26P, with the thickness of the horizontal top flange 82 of meeting rail 81 may cause the tabs to protrude downward to engage the vertical side flange 92 of stile 91 insufficiently.

Another feature may be incorporated into the latch of the current invention, which is the shape of the protrusions 24P/26P, which may be seen to be undulating in the profile view of the latch in FIG. 7B, rather than having a constant rectangular cross-section. This undulating shape may be set to typically result in the nominal distance Dₙₒₘ between the protrusions 24P/26P and the overhanging top wall section 27 being somewhat smaller than the thickness of the horizontal top flange 82 of meeting rail 81, so that upon installation of the latch 101, a small calculated amount/range of compression of the rounded upper portion of the undulating protrusions 24P/26P may be expected, and may serve to provide a slight interference fit with the annular protrusion 25P. This interference fit may help ensure more consistent depth penetration of the shaped structural tabs into the sash frame. For that reason, an embodiment of the latch where the protrusions 24P/26P do not interconnect with the annular protrusion 25P may be advantageous, as the interference fit may only be necessary/advantageous for the latch-to-sash-frame engagement that occurs proximate to the tabs, and annular protrusion 25P may instead be constructed with a modest clearance fit.

Other features that must be carefully considered and calibrated for optimum performance include the angle of the slanted sides 32S, 33S, and 44S. The angle of the slanted sides must be calibrated with the designed-in degree of flexibility of the platforms 31/41 so that as the latch is being slid into the meeting rail 81 through the rectangular opening 92R of the stile 91, the resulting contact with the vertical side flange 92 will cause only elastic deflection of the shaped structural tabs, and no damage thereto.

If a larger tab is utilized, such as for tab 44, the slanted side 44S may need to be at a somewhat steeper angle, particularly because of the close proximity of tab 44 to tab 33. The angle can be minimized slightly by use of a smaller flat side 32F, 33F, and 44F; however, an extremely small flat approaching a knife edge is extremely undesirable as it may result in undesirable permanent deformation of the tip of the tabs 32/33/44, as they pass by the vertical side flange 92.

The examples and descriptions provided merely illustrate a preferred embodiment of the present invention. Those skilled in the art and having the benefit of the present disclosure will appreciate that further embodiments may be implemented with various changes within the scope of the present invention. Other modifications, substitutions, omissions and changes may be made in the design, size, materials used or proportions, operating conditions, assembly sequence, or arrangement or positioning of elements and members of the preferred embodiment without departing from the spirit of this invention.

We claim:

1. A latch, for use in a tiltable sash window, said latch comprising:
a housing; said housing comprising: a top plate, a side wall, and a bottom wall; said housing having a first end and a second end; said sidewall extending from at least a portion of a bottom surface of said top plate; said top plate extending a distance beyond at least a portion of said side wall; said bottom wall connecting to at least a portion of said side wall; said top plate, said side wall, and said bottom wall forming a cavity; said side wall comprising a protrusion configured to protrude from at least a portion of said side wall; said housing comprising a first opening into said cavity at said first end of said housing; said bottom wall comprising: a contoured peripheral opening configured to form a first flexible platform and a second flexible platform within said bottom wall; each of said first and second platforms comprising one or more tabs each having a first surface and a second surface converging to form an apex, said one or more tabs on said first and second platforms being configured to have said first surface selectively secure said latch during installation for varying sash window frame set-back distances, and said second surface of said one or more tabs being configured to cause a corresponding one of said first and second platforms to elastically deflect into said cavity when being engaged;
a spring; and
a latch bolt, said latch bolt being slidably disposed within said cavity of said housing; said spring being configured to bias said latch bolt relative to said housing to normally have a portion of a first end of said latch bolt protrude from said first opening in said housing;

2. The latch according to claim 1 wherein said first platform is proximate to said first end of said housing; and wherein said first platform comprises a first tab, said first tab comprising a notch providing a third surface being generally parallel to said first surface of said first tab, said first and said third surfaces of said first tab being configured for installation of said latch for a zero sash window frame set-back distance.

3. The latch according to claim 2 wherein said bottom surface of said top plate is generally flat; and wherein said first surface of each of said tabs is roughly orthogonal to said bottom surface of said top plate of said housing.

4. The latch according to claim 3 wherein said second surface of said one or more tabs being configured to elastically deflect into said cavity comprises said second surface being generally flat and being at an acute angle to said first surface.

5. The latch according to claim 3 wherein said second surface of said one or more tabs being configured to elastically deflect into said cavity comprises said second surface being curved and forming at an acute angle with said first surface at said apex.

6. The latch according to claim 4 wherein said one or more tabs on said first and second platforms being configured to have said first surface accommodate installation of said latch for varying sash window frame set-back distances comprises said one or more tabs being selectively spaced apart.

7. The latch according to claim 6 wherein said side wall comprises a semi-circular wall portion, and a first straight portion and a second straight portion extending from each end of said semi-circular wall portion.

8. The latch according to claim 7 wherein each of said one or more tabs protrudes from a respective one of said first and second platforms to be generally centered between said first and second straight portions of said side wall.

9. The latch according to claim 8 wherein said contoured peripheral opening in said bottom wall is configured to form an L-shaped for said first platform.

10. The latch according to claim 9 wherein said contoured peripheral opening in said bottom wall is configured to form a T-shape for said second platform.

11. The latch according to claim 10 wherein said protrusion protrudes from said side wall to be generally parallel to said bottom surface of said top plate.

12. The latch according to claim 11 wherein a portion of said protrusion being proximate to said housing first end comprises an undulating top surface.

13. The latch according to claim 12 further comprising a button configured to actuate said latch bolt, a portion of said button being fixedly secured within said latch bolt.

14. The latch according to claim 13 wherein said spring is configured to limit travel of said latch bolt out said first opening in said housing.

15. The latch according to claim 13 wherein said portion of said button fixedly secured within said latch bolt is configured to be engage a portion of said housing in said cavity to limit travel of said latch bolt out said first opening in said housing.

16. A latch, for use in a tiltable sash window, said latch comprising:
a housing; said housing comprising: a top plate, a side wall, and a bottom wall; said housing having a first end and a second end; said sidewall extending from at least a portion of a bottom surface of said top plate; said top plate extending a distance beyond at least a portion of said side wall; said bottom wall connecting to at least a portion of said side wall; said top plate, said side wall, and said bottom wall forming a cavity; said side wall comprising a protrusion configured to protrude from at least a portion of said side wall; said housing comprising a first opening into said cavity at said first end of said housing; said bottom wall comprising: a tab means configured to accommodate varying set-back distances associated with varying cross-sectional arrangements of different sash frames;
a spring; and
a latch bolt, said latch bolt being slidably disposed within said cavity of said housing; said spring being configured to bias said latch bolt relative to said housing to normally have a portion of a first end of said latch bolt protrude from said first opening in said housing;
